(19) United States
(12) Patent Application Publication
(10) Pub. No.: US 2007/0177479 A1
(43) Pub. Date: Aug. 2, 2007

(54) Information reproducing apparatus and information reproducing method

(75) Inventors: Yukiyasu Tatsuzawa, Minato-ku (JP); Hideyuki Yamakawa, Minato-ku (JP); Takayuki Mori, Minato-ku (JP); Takahiro Nango, Minato-ku (JP); Toshihiko Kaneshige, Minato-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/498,792

(22) Filed: Aug. 4, 2006

(30) Foreign Application Priority Data
Jan. 30, 2006 (JP) 2006-021185

(51) Int. Cl. G11B 20/10

(52) U.S. Cl. 369/59.22

(57) ABSTRACT

An information reproducing apparatus reads information recorded on a recording medium and outputs a reproduced signal, and performs, for the reproduced signal, analog offset correction of correcting offset before AD conversion, digital offset correction of correcting offset after AD conversion, and offset detection of detecting an offset control amount from a corrected reproduced signal after the digital offset correction. Further, the information reproducing apparatus divides offset data indicating the detected offset control amount into first offset data of a least significant bit unit for the AD conversion of the reproduced signal or greater and second offset data less than the least significant bit unit so as to perform the digital offset correction using the first offset data and perform the analog offset correction using the second offset data.

### FIELD OF THE INVENTION

The present invention relates to an information reproducing apparatus for performing signal processing by a PRML system, such as an optical disk device, a hard disk drive or the like, and an information reproducing method.

### BACKGROUND OF THE INVENTION

Conventional examples of a recording medium which digital data can be recorded on and reproduced from include an optical disk and a magnetic disk as represented by a DVD (digital versatile disk). The optical disk of them, for example, a DVD-RAM that is one of the DVD family has a recording layer for signals incorporated in the recording medium (disk), so that a laser beam having appropriate energy is applied to the recording layer to change the crystal state in the recording layer, and a laser beam having appropriate energy is applied again to the recording layer to obtain an amount of reflected light corresponding to the crystal state in the recording layer. The reflected light is detected to reproduce the digital data.

In recent years, an information reproducing apparatus for reproducing digital data recorded on a recording medium such as an optical disk or the like, an information recording apparatus for recording digital data on the recording medium, and a hard disk drive using an MR head employ a technology of a system called PRML (Partial Response Maximum Likelihood) (PRML technology) in order to realize high density recording and reproduction.

The technical contents of the PRML technology are disclosed, for example, in Japanese Patent Application Laid-open No. 2001-195830 and so on, and will be briefly described below.

The partial response system (PR) is a system of reproducing digital data by compressing a necessary signal band by positively utilizing the inter-symbol interference (interference between reproduced signals due to pits recorded adjacent to each other entering a light spot) to thereby realize a reproducing circuit requiring no high-frequency component.

The partial response system (PR) has a plurality of characteristics in the way of producing allowed inter-symbol interference, and those systems can be classified into a plurality of types of systems. For example, in the case of class 1, with respect to recorded data “1,” reproduced data “11” can be obtained as two-bit data which produces inter-symbol interference with subsequent 1 bit.

Besides, the Viterbi decoding system (ML), which is one kind of a so-called maximum likelihood sequence estimation system, reproduces digital data based on information of the signal amplitude over a plurality of points in time by effectively using the rule for inter-symbol interference of a reproduced waveform. In this Viterbi decoding system (ML), a synchronization clock in synchronism with the reproduced waveform obtained from a recording medium is generated and used to sample the reproduced waveform itself, which is converted to amplitude information and then subjected to appropriate waveform equalization, whereby the reproduced waveform is converted to a response waveform in the predetermined partial response system. Furthermore, a Viterbi decoding unit uses past and current sample data to estimate a maximum likelihood data sequence and outputs it as reproduced data.

A system obtained by combining the above partial response system and the Viterbi decoding system is referred to as the PRML system. For practical use of the PRML technology, a highly accurate adaptive equalization technique to make the reproduced signal a response with the applied PR characteristic and a highly accurate clock reproduction technique for supporting the adaptive equalization technique are necessary.

Next, a run-length limited code used in the PRML technology will be described. In a reproduction circuit employing the PRML technology, from the produced signal itself read from the recording medium, a clock in synchronism with it is generated, but the polarity of the recorded digital data (recorded signal) needs to be reversed within a predetermined time period in order to generate a stable clock. Concurrently with the reversal, it is necessary to prevent the polarity of the recorded signal from being reversed within a predetermined time period in order to reduce the maximum frequency of the recorded signal.

The maximum data length within which the polarity of the recorded signal is not reversed is referred to as a maximum run-length, while the minimum data length within which the polarity is not reversed is referred to as a minimum run-length. The modulation rule with the maximum run-length of 8 bits and the minimum run-length of 2 bits is referred to as (1, 7)RLL, and the modulation rule with the maximum run-length of 8 bits and the minimum run-length of 3 bits is referred to as (2, 7) RLL. Exemplary modulation/demodulation systems used in the optical disk include the (1, 7)RLL and an EFM Plus (see, for example, U.S. Pat. No. 5,696,505).

A reproduction circuit employing such PRML technology is anticipated to improve in reproduction ability as compared to a conventional slice type reproduction circuit. In particular, an HD DVD (High Definition-DVD) being one of high-capacity optical disks having a high recording capacity corresponding to high-definition television employs the PRML technology as a standard to increase the line recording density for realization of the high capacity.

### SUMMARY OF THE INVENTION

However, even the above-described PRML technology is not versatile. The PRML technology, which is a technology to convert the information in the band direction to the information in the amplitude direction to allow the band to be compressed, has a property of the variable margin in the amplitude direction being smaller than that of the conventional slice type reproduction circuit. More specifically, in the PRML technology, the waveform after the waveform equalization by the PR system is sliced at multilevel to obtain the amplitude information. Therefore if there are variations in amplitude and asymmetry in the reproduced signal, in addition an offset component (also referred to as offset) due to asymmetry or electric factors in circuits such as an amplifier, ADC and the like is superimposed on the reproduced signal, the following problem arises.

Namely, the problem is that the aforementioned factors and so on affect the reproduction quality to a higher degree than in the conventional slicing system, so that deterioration in error rate is unavoidable even if the maximum likelihood decoding is performed by the Viterbi decoding system.

In particular, the influence of the offset component exerted on the reproduction quality is great in the PRML technology. FIG. 8 is a diagram showing a histogram of an equalized waveform (7 bits) when the reproduced waveform of an HD DVD-ROM is subjected to waveform equalization according to the PR(3443) characteristic. In the PR(3443) characteristic, there are ideal amplitude levels at four levels (in this case, 0, 7, 28, and 49) and therefore points of multilevel slice are seven points (0, ±7, ±28, and ±49), so that if the offset component of only 1 LSB (Least Significant Bit) remains, it will exert influence as the offset at all of the seven points of multilevel slice. In the case of the PR(12221) characteristic, the number of ideal amplitude levels (the number of levels) further increases to cause the influence more significant. FIG. 9 is a diagram showing the influence in the case of the PR(12221) characteristic. In FIG. 9, SbER (Simulated bit Error Rate) when offset is added to the equalized waveform obtained by waveform-equalizing the reproduced waveform of an HD DVD-ROM according to the PR(12221) characteristic. This shows that deviation by 1 LSB degrades SbER by nearly one digit in this reproduced waveform.

As described above, a sufficient accuracy is required for a correction circuit for performing correction of the offset component (offset correction) in the reproduction circuit employing the PRML system, and therefore various techniques relating to the detection system and control system of offset as a way to increase the accuracy of the correction circuit have been conventionally proposed.

On the other hand, in the optical disk, in addition to the demand for an increase in the accuracy of the correction circuit for performing offset correction so as to improve the reproduction ability, a demand for high-speed reproduction processing is also increased. To cope with the high-speed reproduction processing, the reproduction circuit also essentially needs to increase in speed. However, the reproduction circuit employing the PRML system is much more complicated in configuration than the conventional slice type reproduction circuit, and therefore an increase in the circuit size accompanying the increased complexity directly causes a bottleneck in increasing the speed.

It is recommended, in the case of an HD DVD, to use an 8-bit ADC (AD Converter) when the estimation index of the reproduction quality of a signal such as SbER or PRSNR (Partial Response Signal to Noise Ratio) is measured, but it is desirable to decrease the number of bits (bit width) of the ADC in order to cope with the high-speed reproduction.

However, when constructing a reproduction circuit using, for example, a 5-bit ADC, calculation in the reproduction circuit needs to be performed also at an accuracy of 5 bits and, in this case, especially the accuracy of the correction circuit for performing offset correction is a problem (because the influence of the accuracy of the offset correction exerted on the reproduction quality is greater than the that of the decrease in the number of bits of the ADC). However, the control value of the correction circuit for performing offset correction is in units of 1 LSB of the ADC, and therefore if the bit width is expanded or the like in order to increase the accuracy of the offset correction because of insufficient accuracy of the correction circuit, the size of the reproduction circuit may increase to hinder the high-speed reproduction.

In particular, since the main stream pass through which the reproduced signal passes tends to be a critical pass of the reproduction circuit in the PRML system, the expansion or the like of bit of the reproduction circuit has a disadvantage, far from an appropriate measure.

Hence, the present invention has been developed to solve the above problems and it is an object of the present invention to enable both an improvement in reproduction ability by improvement in accuracy of the offset correction greatly affecting the signal identification ability, and a high-speed reproduction processing in an information reproducing apparatus and an information reproducing method each for performing signal processing by the PRML system.

To solve the above problems, the present invention provides an information reproducing apparatus including a reproduced signal output means for reading information recorded on a recording medium and outputting a reproduced signal and a PRML signal processing means for performing signal processing by the PRML system, the apparatus including: an analog offset correction means for performing offset correction for the reproduced signal outputted from the reproduced signal output means before AD conversion; a digital offset correction means for performing offset correction for a digital reproduced signal, the digital reproduced signal being obtained after AD conversion of the reproduced signal outputted from the reproduced signal output means; an offset detection means for detecting, from a corrected reproduced signal, an offset control amount contained in the corrected reproduced signal, the corrected reproduced signal being obtained after correction by the digital offset correction means; and a division means for dividing offset data indicating the offset control amount detected by the offset detection means into first offset data of a least significant bit unit or greater and second offset data less than the least significant bit unit, the least significant bit unit being a unit for the AD conversion of the reproduced signal, wherein the digital offset correction means is capable of the offset correction using the first offset data divided by the division means and the analog offset correction means is capable of the offset correction using the second offset data.

The information reproducing apparatus divides offset data indicating the detected offset control amount into first offset data of a least significant bit unit for the AD conversion or greater and second offset data less than the least significant bit unit so as to perform the digital offset correction using the first offset data and perform the analog offset correction using the second offset data.

The present invention will be more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a block diagram showing a circuit configuration of the inside of an information reproducing apparatus according to an embodiment of the present invention;

FIG. 2 is a block diagram showing an example of a circuit configuration of an adaptive equalizer;

FIG. 3 is a block diagram showing an example of a circuit configuration of an offset detector;

FIG. 4 is a block diagram showing a circuit configuration of the inside of an information reproducing apparatus according to a modification example;

FIG. 5 is a block diagram showing a circuit configuration of another offset detector;

FIG. 6 is a block diagram showing a circuit configuration of the inside of an information reproducing apparatus according to another modification example;

FIG. 7 is a block diagram showing an example of a circuit configuration of another offset detector;

FIG. 8 is a diagram showing a histogram of an equalized waveform (7 bits) when a reproduced waveform of an HD DVD-ROM is subjected to waveform equalization according to the PR(3443) characteristic; and

FIG. 9 is a diagram showing SbER when offset is added to the equalized waveform obtained by waveform-equalizing the reproduced waveform of an HD DVD-ROM according to the PR(12221) characteristic.

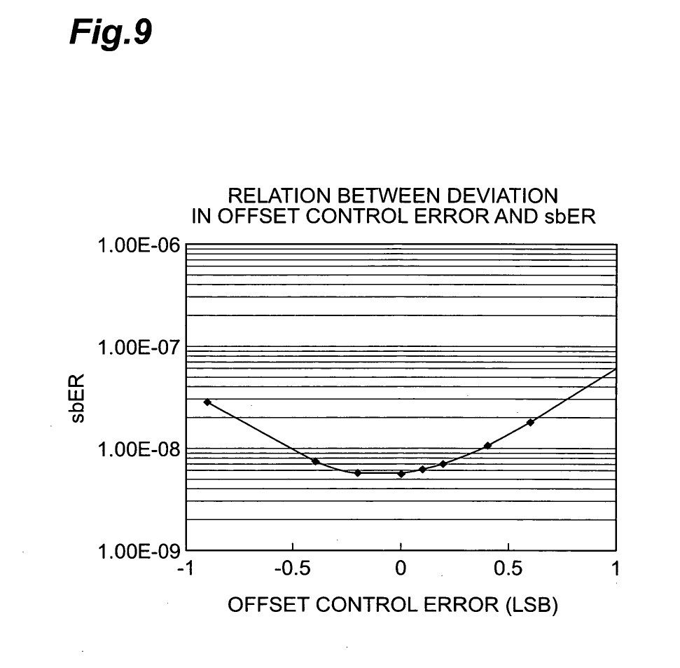

### DESCRIPTION OF THE PREFERRED EMBODIMENTS

Hereinafter, an embodiment of the present invention will be described with reference to the drawings. Note that the same numbers and symbols are used for the same components to omit redundant description.

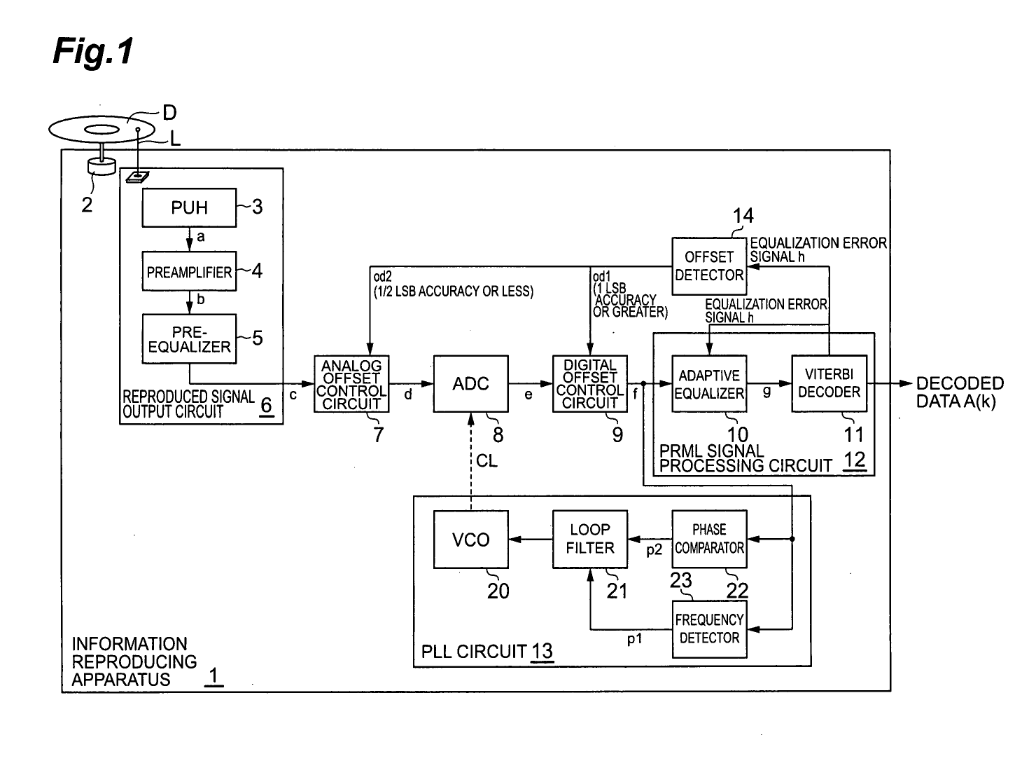

An information reproducing apparatus 1 according to an embodiment of the present invention, employing an optical disk D as a recording medium as shown in FIG. 1, can reproduce digital data recorded on the optical disk D. The information reproducing apparatus 1 has a drive mechanism 2 for holding the optical disk D and rotating it at a predetermined number of rotations, and a reproduced signal output circuit 6 composed of a PUH (Pick up head) 3 with an optical pick up and so on, a preamplifier 4, and a pre-equalizer 5.

The PUH 3 applies an appropriate laser beam L to the optical disk D, detects its reflected light from the optical disk D, and outputs a reproduced signal a as a week analogue signal to the preamplifier 4. The preamplifier 4 performs processing such as amplification and the like for the reproduced signal a outputted from the PUH 3 and outputs a reproduced signal b, which has reached a sufficient signal level, to the pre-equalizer 5. The pre-equalizer 5 performs previous waveform equalization for the reproduced signal b which has been subjected to the processing such as amplification and the like in the preamplifier 4 and outputs a reproduced signal c after the waveform equalization.

Further, the information reproducing apparatus 1 has an analog offset control circuit 7, an ADC (AD Converter) 8, a digital offset control circuit 9, a PRML signal processing circuit 12 including an adaptive equalizer 10 and a Viterbi decoder 11 and performing signal processing by the PRML system, a PLL (Phase Locked Loop) circuit 13, and an offset detector 14.

The analogue offset control circuit 7 receives the reproduced signal c inputted from the pre-equalizer 5 and a feedback of offset data od2 with ½ LSB accuracy, ¼ LSB accuracy . . . less than 1 LSB accuracy of the ADC 8 of offset data od generated in the offset detector 14. The analogue offset control circuit 7 performs offset correction (analogue offset correction) to add the offset data od2 to the reproduced signal c before AD conversion by the ADC 8 and outputs a reproduced signal d.

The reasons why only the offset data od2 with an accuracy of ½ LSB or less of the offset data od is fed back to the analogue offset control circuit 7 are as shown in the following 1), 2), and 3).

First, 1) when only the digital offset control circuit 9 is used to attempt to perform offset correction to an accuracy of ½ LSB or less, the analogue offset control circuit 7 is not necessary, resulting in a configuration undesirable both to increase the speed of reproduction processing and to improve the reproduction ability. Second, 2) the analogue offset control circuit 7 can perform correction to an accuracy ½ LSB or less, but if it corrects all of the offset data od, the data can exceed the dynamic range of the ADC 8 (particularly when the asymmetry of the optical disk D is large). Third, 3) while a circuit created, for example, by MOS process is considered as the circuit capable of performing analog offset correction, it is generally difficult to increase the control range of the offset correction in the MOS process.

For these reasons, the information reproducing apparatus 1 is configured such that the analogue offset control circuit 7 performs offset correction within a smaller range of an accuracy ½ LSB or less which is smaller than the least significant bit unit for the AD conversion in the ADC 8 of the divided offset data od, and the digital offset control circuit 9 performs offset correction within a larger range of an accuracy of 1 LSB or greater which is the least significant bit unit or greater.

Next, the ADC 8 converts the level value of the reproduced signal d inputted thereinto to a digital value and outputs a resulting digital reproduced signal e. Note that, in order to cope with high-speed reproduction, it is possible to reduce the number of bits of the ADC 8 as long as the reproduction quality never deteriorates. The number of bits can be reduced to about 6 bits since it has been known that there is no great difference in BER (Byte error rate) in that range.

In the information reproducing apparatus 1, a conversion clock CL to the ADC 8 is extracted from the reproduced waveform itself so that the sampling timing is appropriate. In other words, a frequency detector 23 constituting the PLL circuit 13 is used to detect, from the reproduced waveform, frequency error information p1 between the frequency of a current reproduced waveform and a target frequency, and a phase comparator 22 similarly constituting the PLL circuit 13 is used to detect phase error information p2 relative to an ideal sampling point for control. This control is conducted by the PLL circuit 13 and configured such that both the frequency control and the phase control are controlled by the same loop filter 21 so that the conversion clock CL is supplied to the ADC 8 by a VCO (Voltage Controlled Oscillator) 20. The frequency error information p1 and the phase error information p2 may be detected using the digital reproduced signal e outputted from the ADC 8. In such a configuration, however, both the frequency error information p1 and the phase error information p2 are affected by the offset component contained in the digital reproduced signal e. For this reason, the information reproducing apparatus 1 according to this embodiment is configured such that the frequency error information p1 and the phase error information p2 are detected from the output (later-described digital data f) of the digital offset control circuit 9. The present invention, however, is not limited to such a configuration.

Next, the digital offset control circuit 9 performs offset correction (digital offset correction) to add offset data od1 with 1 LSB accuracy for the digital reproduced signal e and outputs the resulting digital data f as a corrected reproduced signal. Because the offset correction with an accuracy of ½ LSB or less has been already performed in the analogue offset control circuit 7, the digital offset control circuit 9 performs offset correction by adding the offset data od1 with 1 LSB accuracy. This offset correction corrects the significant offset created by the asymmetric component or the like.

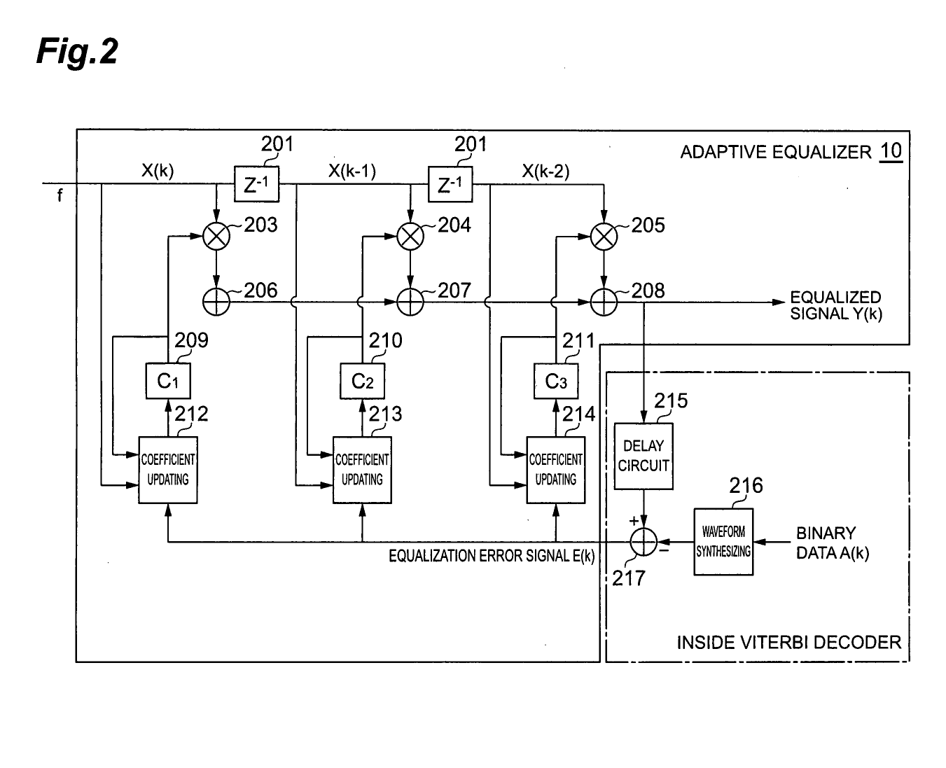

Next, the adaptive equalizer 10 and the Viterbi decoder 11 in combination constitute the PRML signal processing circuit 12 in the present invention. The adaptive equalizer 10 performs waveform equalization for the digital data f which has been subjected to the offset correction by the digital offset control circuit 9 so as to make a response of a predetermined applied PR characteristic (while PR(3443) characteristic is applied in the information reproducing apparatus 1 in this embodiment, other characteristics are also applicable), and outputs its resulting equalized waveform data g. Referring now to FIG. 2, the circuit configuration and adaptive learning of the adaptive equalizer 10 will be described.

FIG. 2 is a block diagram showing an example of the circuit configuration of the adaptive equalizer 10. Note that the configuration inside the Viterbi decoder 11 (a portion inside a broken line in FIG. 2) is also included in FIG. 2 for convenience of illustration. The adaptive equalizer 10 has delay circuits 201 and 202, multipliers 203, 204, and, 205, adding circuits 206, 207, and 208, registers 209, 210, and 211, and coefficient updating circuits 212, 213, and 214.

Each of the delay circuits 201 and 202 delays an input signal by one clock and output the resulting signal. Each of the multipliers 203, 204, and 205 outputs a product of two input signals inputted thereto. Each of the adding circuits 206, 207, and 208 outputs a sum of two input signals inputted thereto. Note that while a 3-tap digital filter using the three multipliers 203, 204, and 205 is shown in the adaptive equalizer 10 shown in FIG. 2, any adaptive equalizer has the same basic operation even if the number of multipliers is different, and therefore the following description is not limited to an adaptive equalizer with the 3-tap filter such as the adaptive equalizer 10. In general, as the number of taps increases, the equalization characteristic increases. However, it is considered that a filter with about 8 taps to about 10 taps is practically often employed because of restraint such as the circuit scale or the like.

It is assumed that an input signal at time k into the adaptive equalizer 10 is X(k) and multiplier factors inputted into the multipliers 203, 204, and 205 are c1, c2, and c3, respectively, an equalized signal Y (k) outputted from the adaptive equalizer 10 is expressed by the following Expression 1.

Y(k)=X(k)×c1+X(k−1)×c2+X(k−2)×c3 Expression 1

It is assumed that the binary data outputted from the Viterbi decoder 11 with respect to Y(k) is A(k). Assuming that the class of a target PR (an applied PR characteristic) is, for example, PR(3443) characteristic and A(k) is correct reproduced data, an original output signal Z(k) (an ideal signal in the present invention) of the adaptive equalizer 10 at time k is expressed by the following Expression 2.

$$Z ( k ) = 3 \times A ( k ) + 4 \times A ( k - 1 ) + 4 \times A ( k - 2 ) + 3 \times A ( k - 3 ) - 7 \qquad Expression 2$$

Hence, an equalization error signal E(k) at time k is defined by the following Expression 3.

E(k)=Y(k)−Z(k) Expression 3

In the adaptive equalizer 10, the adaptive learning is performed by updating the respective coefficients of the multipliers 203, 204, and 205 according to the following Expressions 4, 5, and 6.

$$\begin{matrix}c 1 ( k + 1 ) = c 1 ( k ) - α \times X ( k ) \times E ( k ) & Expression 4 \\ c 2 ( k + 1 ) = c 2 ( k ) - α \times X ( k - 1 ) \times E ( k ) & Expression 4 \\ c 3 ( k + 1 ) = c 3 ( k ) - α \times X ( k - 2 ) \times E ( k ) & Expression 4\end{matrix}$$

In the above expressions, a is an updating coefficient and set to a positive small value (for example, 0.01). What performs the processing shown in the above Expression 2 is a waveform synthesizing circuit 216 provided in the Viterbi decoder 11. Further, a delay circuit 215 in the Viterbi decoder 11 performs delay processing corresponding to a processing period in the Viterbi decoder 11 for the equalized signal Y(k) from the adding circuit 208, and an adding circuit 217 performs the processing expressed by the above Expression 3. The coefficient updating circuit 212 performs the calculation expressed by Expression 4 to update the coefficient in the multiplier 203 so that the updated result is stored in the register 209. The coefficient updating circuit 213 performs the calculation expressed by Expression 5 to update the coefficient in the multiplier 204 so that the updated result is stored in the register 210. The coefficient updating circuit 214 performs the calculation expressed by Expression 6 to update the coefficient in the multiplier 205 so that the updated result is stored in the register 211.

In the adaptive equalizer 10, the adaptive learning is performed in the above manner to obtain a desired equalized waveform. Further, the equalized waveform data g (the equalized signal Y(k)) outputted from the adaptive equalizer 10 is inputted into the Viterbi decoder 11. The Viterbi decoder 11 then performs maximum likelihood sequence estimation (Viterbi decoding) and thereby outputs final binary data A(k) (decoded data)

Basically, the offset detector 14 is only required to detect the amount of DC component in the reproduced signal (because of sufficient DC suppression with a modulation code). Since there are slice points other than the zero-point as described above in the PRML system, the error rate can be improved more by a control to minimize the equalization error if there is asymmetry.

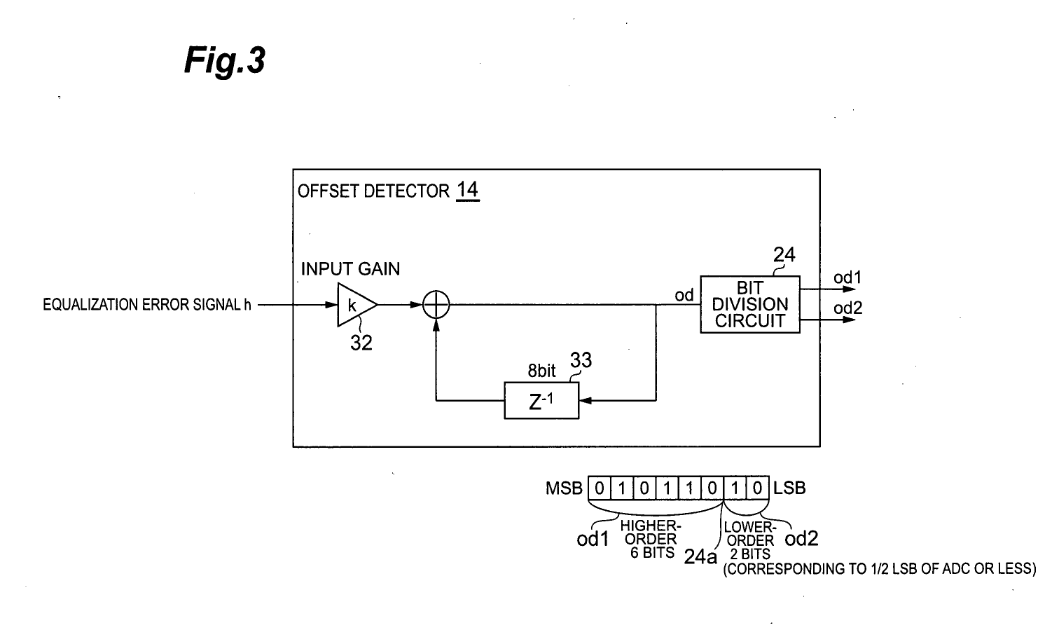

Preferably, the offset detector 14 has, for example, a configuration to detect the offset control amount as a primary control by an integrator as shown in FIG. 3. The offset detector 14 shown in FIG. 3, which has an input gain 32 and a delay circuit 33 for delaying an input signal by one clock and outputting a resulting signal, receives an equalization error signal h (E(k)) and adjusts the control band for the offset control by the input gain 32 (an amplifier for multiplying the input value by k). As the setting of the input gain 32 is made larger, the response speed increases, while the setting of the input gain 32 is made smaller, the response speed decreases. The integral value obtained by multiplying the data value of the equalization error signal h by k is the offset data od (8-bit data in this embodiment) indicating the detected offset control amount.

The offset detector 14 further has a bit division circuit 24 as a dividing means which is a feature of the present invention. The bit division circuit 24 performs division by in units of bit for the offset data od (bit division) and outputs the offset data od1 as first offset data and the offset data od2 as second offset data in the present invention. The offset detector 14 is connected to the digital offset control circuit 9 and the analog offset control circuit 7 such that the offset data od1 is inputted into the digital offset control circuit 9 and the offset data od2 is inputted into the analog offset control circuit 7.

This configuration allows the digital offset control circuit 9 to perform offset correction for an accuracy of 1 LSB of the ADC 8 or greater and the analog offset control circuit 7 to perform offset correction for an accuracy of ½ or less in the information reproducing apparatus 1. It should be noted that the resolution in this embodiment is such that data of higher-order 6 bits (the first offset data) of the offset data od of 8 bits corresponds to an accuracy of 1 LSB of the ADC 8 or greater and data of lower-order 2 bits (the second offset data) corresponds to an accuracy of ½ LSB or less.

As described above, in the information reproducing apparatus 1, the bit division circuit 24 provided in the offset detector 14 performs bit division of the offset data od and outputs the offset data od1 of the least significant bit unit which is AD-converted by the ADC 8 (1 LSB accuracy) or greater and the offset data od2 less than the least significant bit unit (½ LSB accuracy or less). The information reproducing apparatus 1 is configured such that the analog offset control circuit 7 performs offset correction within a smaller range of an accuracy of ½ LSB or less using the offset data od2, and the digital offset control circuit 9 performs offset correction within a larger range of an accuracy 1 LSB or greater using the offset data od1.

This ensures that, in the information reproducing apparatus 1, even when the number of bits of the ADC 8 is reduced, for example, down to 6 bits to cope with the high-speed reproduction, accompanied by a decrease in accuracy of the digital offset control circuit 9, the accuracy of offset correction can be improved as a whole apparatus because offset correction with a higher accuracy of the bit accuracy of the ADC 8 or greater is performed in the analog offset control circuit 7, whereby the reproduction ability can be improved. In addition, the improvement in the reproduction ability is made without bit expansion or the like inside the circuit for processing the digital data, and therefore also attains with the increase in speed.

Accordingly, in the information reproducing apparatus 1, offset correction suitable for characteristics of both the analog offset control circuit 7 and the digital offset control circuit 9 as described above can be performed to achieve both an improvement in the production ability by improvement in accuracy of the offset correction, and high-speed reproduction processing.

### MODIFICATION EXAMPLE 1

In an information reproducing apparatus including the PRML signal processing means such as the above-described information reproducing apparatus 1, the required accuracy for offset correction is different depending on the applied PR characteristic. For example, a higher accuracy is required in the case where the applied PR characteristic is PR(12221) characteristic than in the case of PR(3443) characteristic as in the above-described information reproducing apparatus 1.

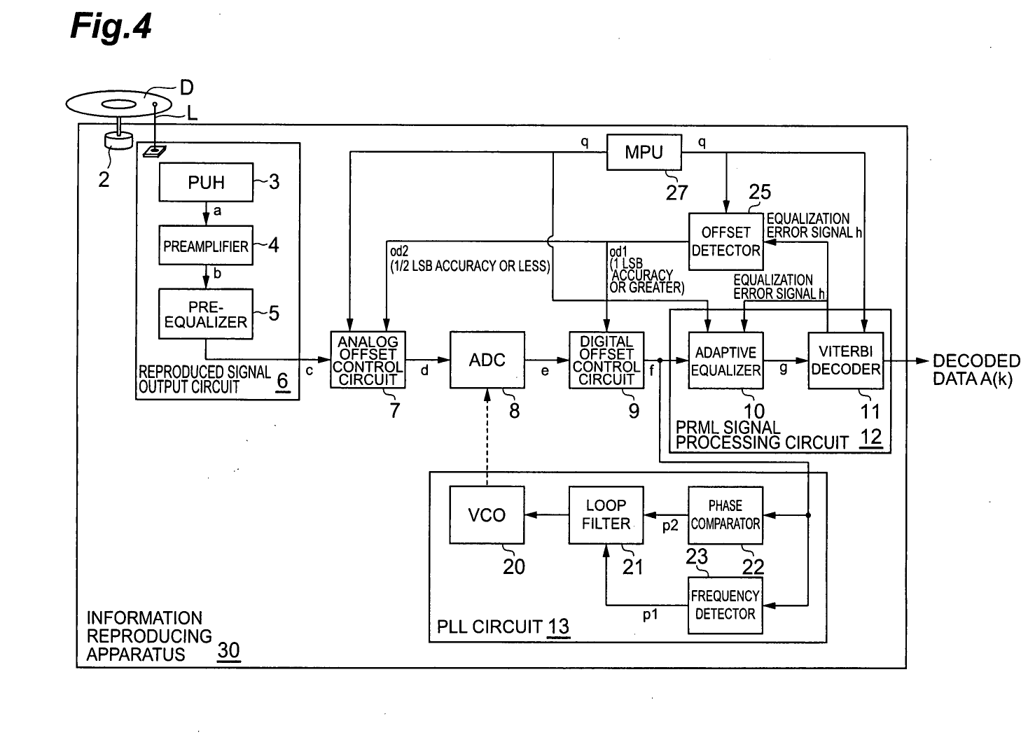

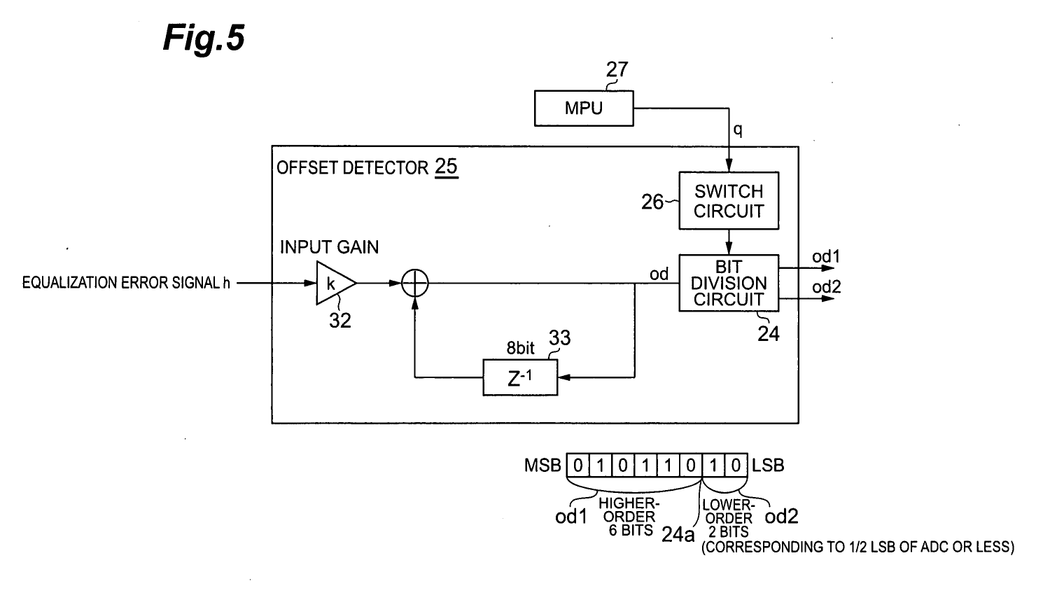

Hence, it is preferable to provide an offset detector 25 in place of the offset detector 14 to form an information reproducing apparatus 30 as shown in FIG. 4. The offset detector 25 has a switch circuit 26 connected to the bit division circuit 24 as shown in FIG. 5 and is configured to change, in units of bit, the division ratio when the offset data od is divided (the respective ratios of the first offset data od1 and the second offset data od2 to the offset data od) according to operation of the switch circuit 26.

The switch circuit 26 operates according to a PR characteristic selection instruction q outputted from a MPU (Micro Processing Unit) 27 according to the applied PR characteristic and has a switch for changing, in units of bit, a division point 24a when the bit division circuit 24 divides bits. When the division point 24a is changed in units of bit, the numbers of bits of the first offset data od1 and the second offset data od2 are changed.

This configuration allows offset correction according to the applied PR characteristic to be performed though the dynamic range of the ADC 8 is reduced, so that the accuracy of the offset correction can be improved. Note that since it is also necessary in this case to change the sensitivity setting per 1 bit of the offset control amount of the analog offset control circuit 7 at the same time, the PR characteristic selection instruction q issued from the MPU 27 is inputted also into the analog offset control circuit 7 in addition to the Viterbi decoder 11 as shown in FIG. 4.

### MODIFICATION EXAMPLE 2

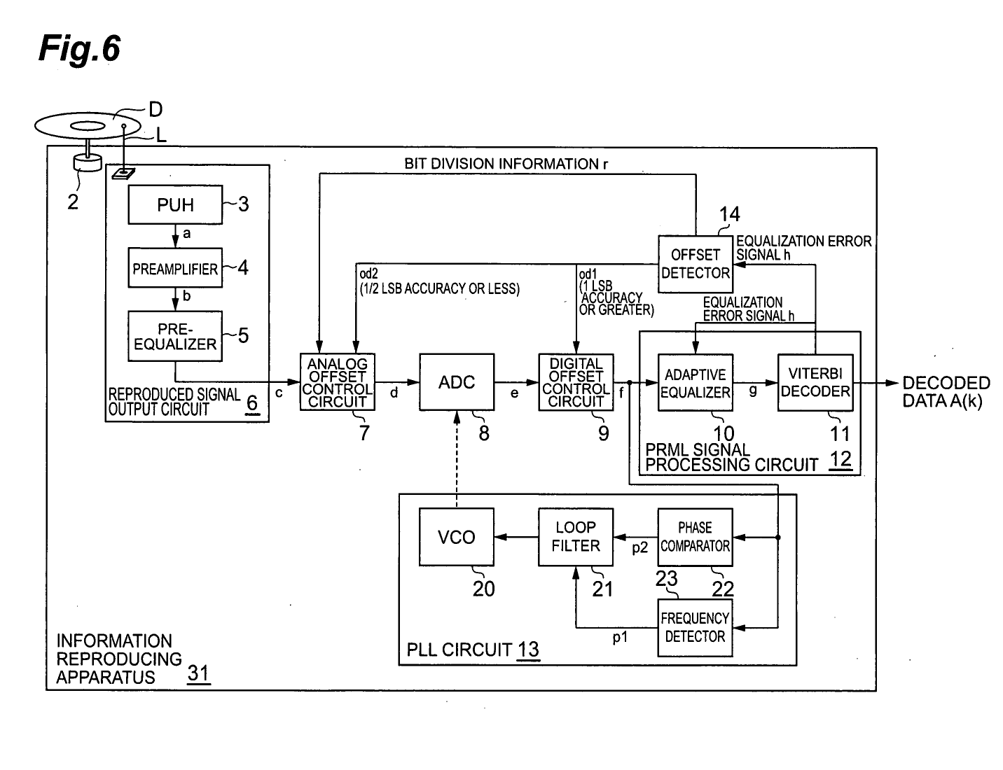

The division ratio of the offset data may be changed by employing a floating point rather than a fixed point. For example, the MPU 27 executes a program for floating the decimal point so that the MPU 27 can operate as a floating means to thereby float the decimal point. This enables application such as distribution of the accuracy of offset correction to the analog offset control circuit 7 and the digital offset control circuit 9 when the dynamic range is low. In this case, bit division information r is inputted from the offset detector 14 to also change dynamically the sensitivity of the analog offset control circuit 7 as in an information reproducing apparatus 31 shown in FIG. 6.

### MODIFICATION EXAMPLE 3

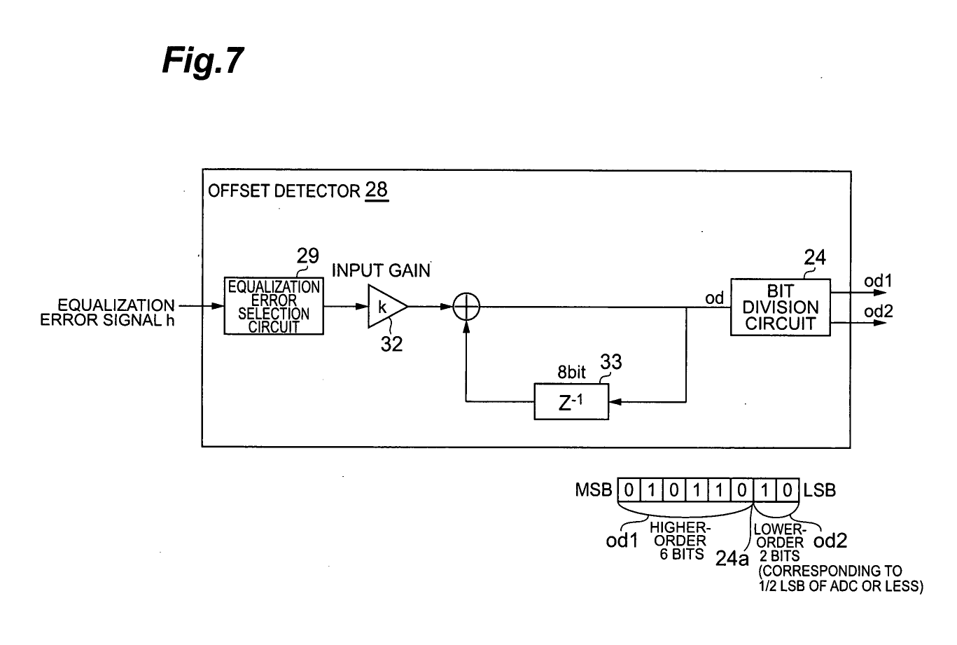

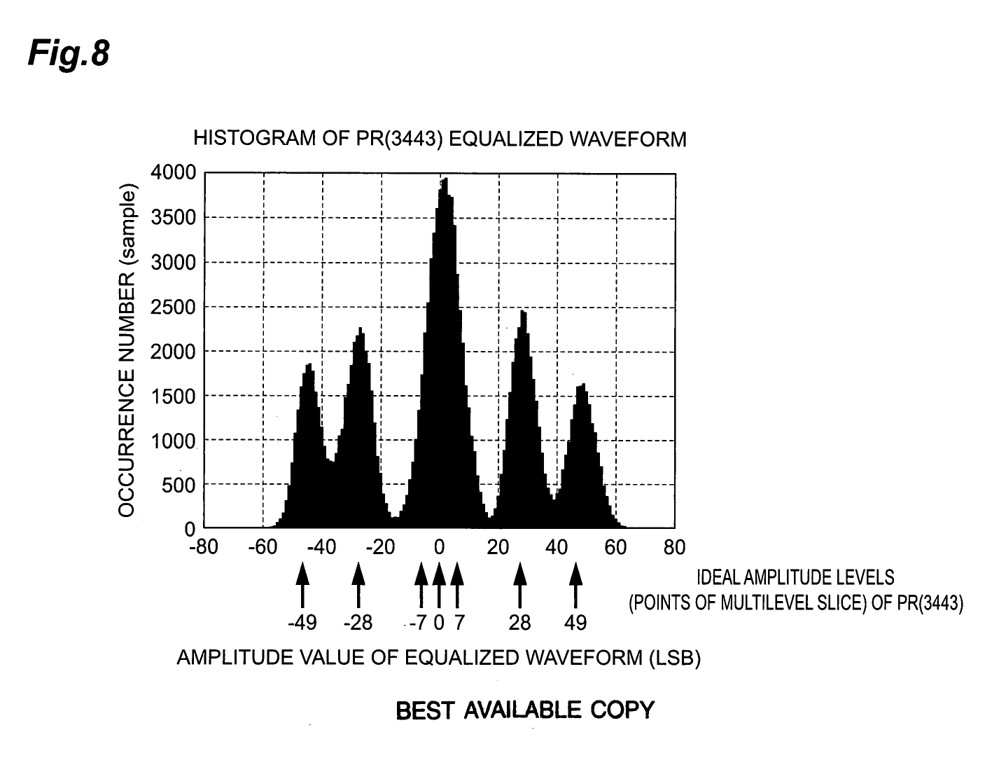

Further, the offset detector may be an offset detector 28 shown in FIG. 7 in addition to the above-described offset detectors 14 and 25. The offset detector 28 is configured to detect the offset control amount based on the equalization error signal as in the offset detectors 14 and 25. The offset detector 28 has an equalization error selection circuit 29 for selecting the equalization error signal, so that the equalization error selection circuit 29 inputs only the equalization error signal at a specific ideal amplitude level into the input gain 32. In this case, the equalization error selection circuit 29 operates to select the equalization error signal, in which the offset control amount is detected only using the equalization error signal, for example, at three points of ±7 and 0 of the ideal amplitude levels of PR(3443) characteristic shown in FIG. 8. In Viterbi decoding, the code determination is performed using the Euclidean distance difference, and the Euclidean distance is small when a signal with a small signal amplitude such as 2T is contained in a pass and thus tends to cause an error. Hence, in the offset detector 28, correction tailored to error equalization error around 2T is performed to reduce the error equalization error around 2T. This configuration presents an effect of allowing the error rate to be smaller than that by the offset detector 14.

Further, the offset detector has only to detect the offset control amount based on the equalization error signal. The equalization error signal correlates with the error rate. Therefore, to increase the correlation, the offset control amount may be detected using a signal evaluation index such as SAM (Sequence Amplitude Margin) obtained by processing the equalization error signal, SbER, or PRSNR.

Such an offset detector can be combined with the above-described two kinds of offset control circuits of the present invention (the analog offset control circuit 7 and the digital offset control circuit 9) to realize an information reproducing apparatus having a higher accuracy of offset correction and high-speed reproduction processing.

Note that while the present invention is described taking, as examples, the information reproducing apparatuses 1, 30, and 31 using an optical disk as a recording medium in this embodiment, the present invention is not limited to the apparatus using the optical disk as a recording medium but also applicable to a hard disk drive using an MR head. While the bit division circuit 24 is provided in the offset detector 14 in the above-described information reproducing apparatus 1, the bit division circuit 24 may not be provided in the offset detector 14.

As has been described in detail, the present invention makes it possible, in an information reproducing apparatus and an information reproducing method each for performing signal processing by the PRML system, to achieve both an improvement in production ability by improvement in accuracy of the offset correction greatly affecting the signal identification ability, and high-speed reproduction processing.

It is apparent that various embodiments and modifications of the present invention can be embodied, based on the above description. Accordingly, it is possible to carry out the present invention in the other modes than the above best mode, within the following scope of claims and the scope of equivalents.

What is claimed is:

1. An information reproducing apparatus comprising a reproduced signal output means for reading information recorded on a recording medium and outputting a reproduced signal and a PRML signal processing means for performing signal processing by the PRML system, said apparatus comprising:
an analog offset correction means for performing offset correction for the reproduced signal outputted from said reproduced signal output means before AD conversion;
a digital offset correction means for performing offset correction for a digital reproduced signal, said digital reproduced signal being obtained after AD conversion of the reproduced signal outputted from said reproduced signal output means;
an offset detection means for detecting, from a corrected reproduced signal, an offset control amount contained in said corrected reproduced signal, said corrected reproduced signal being obtained after correction by said digital offset correction means; and
a division means for dividing offset data indicating the offset control amount detected by said offset detection means into first offset data of a least significant bit unit or greater and second offset data less than said least significant bit unit, said least significant bit unit being a unit for the AD conversion of the reproduced signal,
wherein said digital offset correction means is capable of the offset correction using the first offset data divided by said division means and said analog offset correction means is capable of the offset correction using the second offset data.

2. The information reproducing apparatus according to claim 1, wherein said offset detection means detects the offset control amount based on an equalization error signal indicating a difference between an ideal signal and an equalized signal, said ideal signal being calculated using a signal outputted from a maximum likelihood decoder provided in said PRML signal processing means for decoding the corrected reproduced signal, and said equalized signal being outputted from an adaptive equalizer provided in said PRML signal processing means for performing waveform equalization for the corrected reproduced signal.

3. The information reproducing apparatus according to claim 1, further comprising:
a changing means for changing, in units of bit, the division ratio when the offset data is divided by said division means according to a PR characteristic applied in said PRML signal processing means.

4. The information reproducing apparatus according to claim 2, further comprising:
a changing means for changing, in units of bit, the division ratio when the offset data is divided by said division means according to a PR characteristic applied in said PRML signal processing means.

5. The information reproducing apparatus according to claim 1, further comprising:
a floating means for floating a decimal point for the division ratio when the offset data is divided by said division means.

6. The information reproducing apparatus according to claim 2, further comprising:
a floating means for floating a decimal point for the division ratio when the offset data is divided by said division means.

7. The information reproducing apparatus according to claim 2, further comprising:
an equalization error selection means for selecting the equalization error signal,
wherein said offset detection means is configured to detect the offset control amount based on the equalization error signal selected by said equalization error selection means.

8. An information reproducing method of reading information recorded on a recording medium and outputting a reproduced signal and performing signal processing by the PRML system, said method comprising the steps of:
performing analog offset correction of correcting offset for the reproduced signal before AD conversion, digital offset correction of correcting offset for a digital reproduced signal, said digital reproduced signal being obtained after AD conversion of the reproduced signal, and offset detection of detecting, from a corrected reproduced signal, an offset control amount contained in said corrected reproduced signal, said corrected reproduced signal being obtained after performance of the digital offset correction; and
dividing offset data indicating the offset control amount detected by said offset detection into first offset data of a least significant bit unit or greater and second offset data less than said least significant bit unit, said least significant bit unit being a unit for the AD conversion of the reproduced signal,
wherein said digital offset correction is performed using the divided first offset data and said analog offset correction is performed using the second offset data.
